(19) United States
(12) Patent Application Publication
(10) Pub. No.: US 2013/0266782 A1
(43) Pub. Date: Oct. 10, 2013

(54) METAL BASE SUBSTRATE

(71) Applicant: MURATA MANUFACTURING CO., LTD., Nagaokakyo-shi (JP)

(72) Inventors: Yoichi MORIYA, Nagaokakyo-shi (JP); Tsuyoshi KATSUBE, Nagaokakyo-shi (JP); Yuki TAKEMORI, Nagaokakyo-shi (JP); Yasutaka SUGIMOTO, Nagaokakyo-shi (JP); Takahiro TAKADA, Nagaokakyo-shi (JP)

(73) Assignee: MURATA MANUFACTURING CO., LTD., Nagaokakyo-shi (JP)

(21) Appl. No.: 13/630,044

(22) Filed: Sep. 28, 2012

Related U.S. Application Data
(63) Continuation of application No. PCT/JP2011/056914, filed on Mar. 30, 2011.

(30) Foreign Application Priority Data
Mar. 30, 2010 (JP) 2010-076686

(51) Int. Cl. B32B 7/02

(52) U.S. Cl. CPC B32B 7/02
USPC 428/213; 428/212

(57) ABSTRACT

In a metal base substrate with a low-temperature sintering ceramic layer provided on a metal substrate, while making it possible to make the metal substrate from copper, the low-temperature sintering ceramic layer is less likely to crack or peel at the interface with the metal substrate, and the anti-peeling strength of a surface conductor is improved. In the metal base substrate, the thermal expansion coefficient of the metal substrate is greater than the thermal expansion coefficient of the low-temperature sintering ceramic layer, the average difference in thermal expansion coefficients of the metal substrate and the low-temperature sintering ceramic layer at approximately 25° C. to 400° C. is about 4 ppm/° C. to about 9 ppm/° C., and the low-temperature sintering ceramic layer has a Young's modulus less than about 120 GPa, and a flexural strength of about 200 MPa or more.

### BACKGROUND OF THE INVENTION

1. Field of the Invention

The present invention relates to a metal base substrate that includes a semiconductor element and other elements mounted thereon, and also provides a heat release function, and more particularly, to a metal base substrate which includes a metal substrate combined with a ceramic layer configured with the use of a low-temperature sintering ceramic material.

2. Description of the Related Art

Metal base substrates have a relatively high heat release function, and have been used advantageously for mounting electronic components which require heat release, such as, for example, a semiconductor element. In the case of these metal base substrates, ceramic materials are used as a material constituting a substrate layer combined with a metal substrate.

For example, a low-temperature sintering ceramic material is a ceramic material which can be sintered at a temperature of 1050° C. or less. Therefore, as long as a metal base substrate has a ceramic layer configured with the use of the low-temperature sintering ceramic material and formed on a metal substrate, the raw low-temperature sintering ceramic layer and the metal substrate can be subjected to co-firing without using a metal substrate composed of a metal which has a very high melting point.

However, when the low-temperature sintering ceramic layer and the metal substrate are subjected to co-firing, peeling at the interface between the low-temperature sintering ceramic layer and the metal substrate, or cracking in the low-temperature sintering ceramic layer may be caused in the process of cooling after the co-firing, because of the difference in thermal expansion coefficients.

Therefore, as a means for solving these problems of peeling between the low-temperature sintering ceramic layer and the metal substrate and cracking in the low-temperature sintering ceramic layer, the low-temperature sintering ceramic layer and the metal substrate are adapted to each other in terms of thermal expansion coefficient.

For example, Japanese Translation of PCT International Application Publication No. 11-511719 and Japanese Translation of PCT International Application Publication No. 11-514627 propose, for co-firing of a metal substrate and a low-temperature sintering ceramic layer, that the thermal expansion coefficient of the metal substrate is matched with the thermal expansion coefficient of the low-temperature sintering ceramic layer, more specifically, the composition of the low-temperature sintering ceramic layer is improved so as to match with the thermal expansion coefficient of the metal substrate, in order to prevent the ceramic layer from being peeled or cracked.

However, the techniques described in Japanese Translation of PCT International Application Publication No. 11-511719 and Japanese Translation of PCT International Application Publication No. 11-514627 have limitations on the improvement in composition of the low-temperature sintering ceramic layer, and thus have a problem that only metals with a low thermal expansion coefficient can be used as the material of the metal substrate. In fact, the techniques described in Japanese Translation of PCT International Application Publication No. 11-511719 and Japanese Translation of PCT International Application Publication No. 11-514627 solve the problems of peeling and cracking by using an alloy with a low thermal expansion coefficient for the metal substrate so as to be close to the thermal expansion coefficient of the low-temperature sintering ceramic layer.

However, the alloy with a low thermal expansion coefficient has a low thermal conductivity. Therefore, the alloy leads to a problem that the metal base substrate is inferior in heat release characteristics, as compared with a case of using a metal with a high thermal conductivity, such as, for example, copper, for the metal substrate.

### SUMMARY OF THE INVENTION

Therefore, preferred embodiments of the present invention provide a metal base substrate that solves the problems as described above.

According to various preferred embodiments of the present invention, even when there is a difference in thermal expansion coefficients of a metal substrate and a low-temperature sintering ceramic layer, new characteristics and requirements that prevent the ceramic layer from being peeled or cracked are used, so as to permit and compensate for the difference in thermal expansion coefficients.

A metal base substrate according to a preferred embodiment of the present invention includes a metal substrate, and a low-temperature sintering ceramic layer located on the metal substrate, wherein a thermal expansion coefficient of the metal substrate is greater than a thermal expansion coefficient of the low-temperature sintering ceramic layer, an average difference in thermal expansion coefficient at approximately 25° C. to 400° C. is about 9 ppm/° C. or less between the metal substrate and the low-temperature sintering ceramic layer, and the low-temperature sintering ceramic layer has a Young's modulus less than about 120 GPa, and a flexural strength thereof of about 200 MPa or more.

The metal base substrate according to a preferred embodiment of the present invention significantly reduces and prevents peeling and cracking in the low-temperature sintering ceramic layer, even when the metal substrate and the ceramic layer which have a difference in thermal expansion coefficients are co-fired in order to obtain the metal base substrate. Therefore, the selection of materials which can be used as the metal substrate or the low-temperature sintering ceramic layer is expanded, thus making it possible to reduce the cost of the metal base substrate. In addition, it becomes possible to use, as the material of the metal substrate, a metal with a high thermal conductivity such as, for example, copper, and the heat release performance of the metal base substrate can be thus improved.

In a preferred embodiment of the present invention, when the average difference in thermal expansion coefficient is adjusted to be about 4 ppm/° C. or more, compressive stress not less than a predetermined stress is applied from the metal substrate to the low-temperature sintering ceramic layer, and a high anti-peeling strength can be thus provided for a conductor provided on the surface of the metal base substrate.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view illustrating an electronic component device including a metal base substrate according to a preferred embodiment of the present invention.

### DETAILED DESCRIPTION OF THE PREFERRED EMBODIMENTS

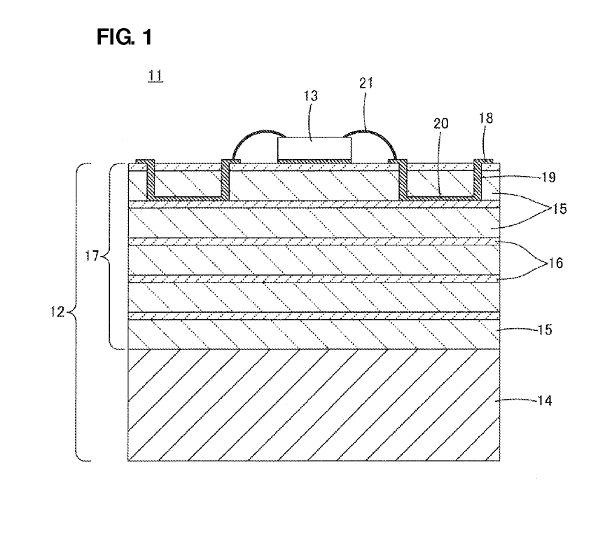

With reference to FIG. 1, first, an electronic component device will be described which includes a metal base substrate according to a preferred embodiment of the present invention.

The electronic component device 11 shown in FIG. 1 includes a metal base substrate 12 and a semiconductor element 13 mounted thereon.

The metal base substrate 12 includes a metal substrate 14, and low-temperature sintering ceramic layers 15 and constraining layers 16 arranged on the metal substrate 14. In this case, the metal substrate 14 has contact with the low-temperature sintering ceramic layer 15. In addition, the low-temperature sintering ceramic layers 15 and the constraining layers 16 are stacked alternately, and the uppermost layer is defined by the constraining layer 16. It is to be noted that the uppermost layer may be provided by the low-temperature sintering ceramic layer 15.

The low-temperature sintering ceramic layer 15 is thicker than the constraining layer 16. As will be evident from the subsequent description of a manufacturing method, the low-temperature sintering ceramic layers 15 preferably include a sintered body of a low-temperature sintering ceramic material. On the other hand, while the constraining layers 16 contain a poorly-sintering ceramic material that is not sintered at the sintering temperature of the low-temperature sintering ceramic material, the low-temperature sintering ceramic material contained in the low-temperature sintering ceramic layers 15 partially flows into the constraining layers 16 during firing, thereby solidifying and densifying the poorly-sintering ceramic material.

In a laminated body section 17 including the low-temperature sintering ceramic layers 15 and the constraining layers 16 in the metal base substrate 12, a circuit pattern is provided. Although the illustration of some circuit patterns is omitted in FIG. 1, for example, some surface conductors 18, some interlayer connecting conductors 19, and some in-plane wiring conductors 20 are formed in connection with the semiconductor element 13. In addition, a specific one of the surface conductors 18 is electrically connected to the semiconductor element 13 via a bonding wire 21.

In use, heat generated in the semiconductor element 13 is conducted through the laminated body section 17 to the metal substrate 14, and released from the metal substrate 14. The metal substrate 14, in order to effectively fulfill the function thereof, preferably contains, for example, copper or silver as its main constituent.

The metal base substrate 12 for use in this electronic component device 11 is preferably manufactured in the following way.

First, the metal substrate 14 is prepared, and also prepared respectively are a low-temperature sintering ceramic slurry containing the low-temperature sintering ceramic material and a poorly-sintering ceramic material containing poorly-sintering ceramic material that is not sintered at the sintering temperature of the low-temperature sintering ceramic material.

Next, low-temperature sintering ceramic green layers composed of the low-temperature sintering ceramic slurry and poorly-sintering ceramic green layers composed of the poorly-sintering ceramic slurry are arranged on the metal substrate 14. In this case, the low-temperature sintering ceramic green layers are intended to serve as the low-temperature sintering ceramic layers 15, whereas the poorly-sintering ceramic green layers are intended to serve as the constraining layers 16. In addition, the surface conductors 18, interlayer connecting conductors 19, and in-plane wiring conductors 20 are provided for specific ceramic green layers, if necessary.

In carrying out the step mentioned above, preferably, a composite green sheet of a low-temperature sintering ceramic green layer overlapped with a poorly-sintering ceramic green layer is obtained by forming the poorly-sintering ceramic slurry into a sheet on a ceramic green sheet obtained through the formation of the low-temperature sintering ceramic slurry into a sheet, and the required number of this composite green sheet is then stacked on the metal substrate 14, and subjected to pressure bonding.

It is to be noted that in place of the method described above, low-temperature sintering ceramic green sheets obtained by forming the low-temperature sintering ceramic slurry into a shape and poorly-sintering ceramic green sheets obtained by forming the poorly-sintering ceramic slurry into a shape may be stacked alternately on the metal substrate 14. Alternatively, the formation of a poorly-sintering ceramic green layer and the formation of a low-temperature sintering ceramic green layer may be repeated on a low-temperature sintering ceramic green sheet.

Next, a step is carried out for co-firing the metal substrate 14, as well as the low-temperature sintering ceramic green layers and the poorly-sintering ceramic green layers. In this co-firing step, the low-temperature sintering ceramic material contained in the low-temperature sintering ceramic green layers is sintered to serve as the low-temperature sintering ceramic layers 15. In addition, this low-temperature sintering ceramic material partially flows into the poorly-sintering ceramic green layers to solidify the poorly-sintering ceramic material contained in the poorly-sintering ceramic green layers, and densify the poorly-sintering ceramic green layers to serve as the constraining layers 16.

The poorly-sintering ceramic green layers are not substantially shrunk in a planar direction in the firing step, and thus acts to significantly reduce and prevent the shrinkage of the low-temperature sintering ceramic green layers in the planar direction. Therefore, the shrinkage in the planar direction is advantageously significantly reduced and prevented in the entire laminated body section composed of the low-temperature sintering ceramic green layers and the poorly-sintering ceramic green layers on the metal substrate 14.

In the metal base substrate 12 obtained in this way, the thermal expansion coefficient of the metal substrate 14 is greater than the thermal expansion coefficient of the low-temperature sintering ceramic layer 15, the average difference in thermal expansion coefficients at approximately 25° C. to 400° C. is adjusted preferably to be about 9 ppm/° C. or less between the metal substrate 14 and the low-temperature sintering ceramic layer 15, the Young's modulus of the low-temperature sintering ceramic layer 15 is adjusted to be less than about 120 GPa, and the flexural strength thereof is adjusted to be about 200 MPa or more, for example.

As described above, the present preferred embodiment of the present invention has significance in that it has been discovered that when there is a difference in thermal expansion coefficient between the metal substrate 14 and the low-temperature sintering ceramic layer 15, peeling between the low-temperature sintering ceramic layer 15 and the metal substrate 14 and cracking in the low-temperature sintering ceramic layer 15 can be significantly reduced and prevented by adding new requirements such as the Young's modulus and flexural strength of the low-temperature sintering ceramic layer 15 while specifying the upper limit of the difference in thermal expansion coefficients.

When the thermal expansion coefficient of the metal substrate 14 is higher as compared with that of the low-temperature sintering ceramic layer 15, compressive stress due to the difference in thermal expansion coefficients is caused in the low-temperature sintering ceramic layer 15 in the process of decreasing the temperature after the co-firing. Then, as the temperature is lowered in the process of decreasing the temperature, the compressive stress is increased. The low Young's modulus means that certain stress is likely to cause a deformation. In the case of a certain flexural strength, the lower Young's modulus is less likely to cause cracking in the low-temperature sintering ceramic layer 15, even when compressive stress is caused by the difference in thermal expansion coefficient between the metal substrate 14 and the low-temperature sintering ceramic layer 15. On the other hand, in the case of a certain Young's modulus, the higher flexural strength is less likely to cause cracking in the low-temperature sintering ceramic layer 15, even when compressive stress is caused by the difference in thermal expansion coefficient between the metal substrate 14 and the low-temperature sintering ceramic layer 15. More specifically, the low-temperature sintering ceramic layer 15 with a Young's modulus decreased to less than about 120 GPa, and a flexural strength increased to about 200 MPa or more, for example, makes it possible to effectively prevent the compressive stress from causing cracking in the low-temperature sintering ceramic layer 15.

It is to be noted that if the average difference in thermal expansion coefficient at approximately 25° C. to 400° C. is greater than about 9 ppm/° C. between the metal substrate 14 and the low-temperature sintering ceramic layer 15, for example, stress due to the difference in thermal expansion coefficient causes the low-temperature sintering ceramic layer 15 to have cracking at the interface with the metal substrate 14 even when the Young's modulus and the flexural strength fall within the ranges as described above.

When the average difference in thermal expansion coefficient at approximately 25° C. to 400° C. is adjusted to be about 4 ppm/° C. or more between the metal substrate 14 and the low-temperature sintering ceramic layer 15, for example, the anti-peeling strength can be improved significantly for conductors provided on the surface of the metal base substrate 4, for example, the surface conductors 18. This is because compressive stress not less than predetermined stress is given from the metal substrate 14 to the low-temperature sintering ceramic layer 15.

As described above, the low-temperature sintering ceramic layer 15 preferably has a Young's modulus adjusted to be less than about 120 GPa, and a flexural strength adjusted to be about 200 MPa or more in the present preferred embodiment of the present invention, while the lower limit of the Young's modulus and the upper limit of the flexural strength can be defined from the technical standpoint of manufacturing the metal base substrate 12. More specifically, the lower limit of the Young's modulus is preferably adjusted to be about 40 GPa because it is difficult to prepare the low-temperature sintering ceramic layer 15 with a Young's modulus less than about 40 GPa, whereas the upper limit of the flexural strength is preferably adjusted to be about 600 MPa because it is difficult to prepare the low-temperature sintering ceramic layer 15 with a flexural strength higher than about 600 MPa, for example.

While the low-temperature sintering ceramic layers 15 provided on the metal substrate 14 partially constitute the laminated body section 17 of the pluralities of low-temperature sintering ceramic layers 15 and constraining layers 16 stacked alternately in the preferred embodiment described above, the present invention can be applied to metal base substrates which have a structure of only low-temperature sintering ceramic layers provided on a metal substrate. In addition, a joining glass layer may be provided between the metal substrate and the low-temperature sintering ceramic layer.

Next, a non-limiting experimental example will be described which was carried out in accordance with a preferred embodiment of the present invention.

Respective powders of BaCO₃, Al₂O₃ (corundum), and SiO₂ (quartz) were prepared, and a mixed powder of these powders was subjected to calcination at a temperature of 840° C. for 120 minutes, thereby preparing a raw material powder 1 with content ratios of: BaO: 37.0 weight %; Al₂O₃: 11.0 weight %; and SiO₂: 52.0 weight %.

On the other hand, respective powders of BaCO₃, Al₂O₃ (corundum), and SiO₂ (amorphous) were prepared, and a mixed powder of these powders was subjected to calcination at a temperature of 840° C. for 120 minutes, thereby preparing a raw material powder 2 with content ratios of: BaO: 37.0 weight %; Al₂O₃: 11.0 weight %; and SiO₂: 52.0 weight %.

Next, the raw material powder 1, the raw material powder 2, an MnCO₃ powder, an Mg(OH)₂ powder, a TiO₂ powder, and a Al₂O₃ (corundum) powder were weighed to provide the weighing ratios shown in Table 1, mixed in an organic solvent with a dispersant added, and subsequently further mixed with the addition of a resin and a plasticizer to obtain a low-temperature sintering ceramic slurry including a low-temperature sintering ceramic material.

Next, after the low-temperature sintering ceramic slurry was subjected to defoaming, ceramic green sheets to serve as low-temperature sintering ceramic green layers of 40 μm in thickness were prepared by a doctor blade method.

It is to be noted that among various constituent elements shown in Table 1, the raw material powder 2 was used to lower the thermal expansion coefficient. As for SiO₂ contained in each of the raw material powders 1 and 2, the amorphous contained in the raw material powder 2 has a lower thermal expansion coefficient than that of the quartz contained in the raw material powders 1. In addition, MnCO₃ is intended to function as a sintering aid. More MnCO₃ decreases the flexural strength. In addition, the quartz added separately from the raw material powder 1 was used for increasing the thermal expansion coefficient. In addition, the Al₂O₃ added separately from the raw material powders 1 and 2 was used for increasing the Young's modulus.

On the other hand, a glass powder composed of BaO, Al₂O₃, SiO₂, MgO, B₂O₃, and Li₂O, and an Al₂O₃ powder were mixed at a ratio of 40 parts by weight to 60 parts by weight in an organic solvent with a dispersant added, and subsequently mixed with the addition of a resin and a plasticizer to obtain a poorly-sintering ceramic slurry including a poorly-sintering ceramic material.

Next, the poorly-sintering ceramic slurry was subjected to defoaming, and then, on the ceramic green sheets mentioned previously, the poorly-sintering ceramic slurry is formed by a doctor blade method into a sheet with a thickness of 3.0 μm. In this way, composite green sheets were obtained for which the low-temperature sintering ceramic green layer provided by the ceramic green sheet was overlapped with the poorly-sintering ceramic green layer formed from the poorly-sintering ceramic slurry.

It is to be noted that it has been confirmed that a ceramic compact obtained by forming the poorly-sintering ceramic slurry alone into a shape is not sintered even when the compact is subjected to firing under the firing condition described later.

TABLE 1

| | Weighing Ratio [weight %] | | | | | | |
|---|---|---|---|---|---|---|---|
| Sam- | Raw | Raw | | | | | |
| ple | Material | Material | | | | | |
| Num- | Powder | Powder | | | | | |
| ber | 1 | 2 | MnCO₃ | Mg(OH)₂ | TiO₂ | Quartz | Al₂O₃ |
| 1 | 20.0 | 70.0 | 7.0 | 1.0 | 2.0 | — | — |
| 2 | 30.0 | 60.0 | 7.0 | 1.0 | 2.0 | — | — |
| 3 | 60.0 | 30.0 | 7.0 | 1.0 | 2.0 | — | — |
| 4 | 90.0 | — | 7.0 | 1.0 | 2.0 | — | — |
| 5 | 79.5 | — | 7.5 | 1.0 | 2.0 | 10.0 | — |
| 6 | 69.0 | — | 8.0 | 1.0 | 2.0 | 20.0 | — |
| 7 | 64.0 | — | 8.0 | 1.0 | 2.0 | 25.0 | — |
| 8 | 79.0 | — | 8.0 | 1.0 | 2.0 | — | 10.0 |
| 9 | 68.0 | — | 9.0 | 1.0 | 2.0 | — | 20.0 |
| 10 | 57.0 | — | 10.0 | 1.0 | 2.0 | — | 30.0 |
| 11 | 85.0 | — | 12.0 | 1.0 | 2.0 | — | — |
| 12 | 83.0 | — | 14.0 | 1.0 | 2.0 | — | — |
| 13 | 81.0 | — | 16.0 | 1.0 | 2.0 | — | — |

Ten of the composite green sheets were stacked, and pressed under the conditions of: temperature: 80° C. and pressure: 150 MPa to prepare a first unfired sample for evaluation with a planar dimension of 30 mm².

This first sample for evaluation, which has a similar configuration after firing to the laminated body section composed of the low-temperature sintering ceramic layers and the constraining layers in the metal base substrate, was provided by itself as a sample for the evaluation of the firing shrinkage ratio, thermal expansion coefficient, Young's modulus, and flexural strength described later.

In addition, a copper plate of 0.8 mm in thickness was prepared as the metal substrate, and ten of the composite green sheets were stacked on the copper plate, and pressed under the conditions of: temperature: 80° C. and pressure: 150 MPa to prepare a second unfired sample for evaluation with a planar dimension of 30 mm², which had the same configuration as the metal base substrate before firing. In this case, the composite green sheet was placed so that the low-temperature sintering ceramic green layer was brought into contact with the copper plate.

This second sample for evaluation was provided as a sample for the evaluation of cracking described later.

In addition, a third unfired sample for evaluation was prepared through the same operation as in the case of the second sample for evaluation, except that a composite green sheet formed with twenty surface conductors of 2 mm² in planar dimension distributed on the principal surface on the poorly-sintering ceramic green layer side of the sheet with the use of a copper paste was used as the composite green sheet to be located in the uppermost layer in the step of stacking the composite green sheets in the process of preparing the second sample for evaluation.

This third sample for evaluation was provided as a sample for the fixing strength measurement for the surface conductor described later.

The first, second, and third samples for evaluation were subjected to firing at the temperature shown in the column “Firing Temperature” in Table 2 for 180 minutes in a reducing atmosphere.

As shown in Table 2, the “Firing Shrinkage Ratio”, “Thermal Expansion Coefficient”, “Young's Modulus”, and “Flexural Strength” were evaluated with the use of the first sample for evaluation.

In particular, as for the “Firing Shrinkage Ratio”, the value obtained by subtracting the length of a side of the first fired sample for evaluation from the length 100 mm of a side of the first unfired sample for evaluation of 30 mm² in planar dimension was divided by 100 mm, and multiplied by 100 to regard the obtained value as the firing shrinkage ratio [%].

In addition, for the “Thermal Expansion Coefficient”, the average thermal expansion coefficient at approximately 25° C. to 400° C. was determined for the first fired sample for evaluation. As for this “Thermal Expansion Coefficient”, the difference from the thermal expansion coefficient of copper, 17 ppm/° C. was determined, which is shown in the column “Difference in Thermal Expansion Coefficient from Copper Plate” of Table 3.

It is to be noted that the evaluation of the “Firing Shrinkage Ratio”, “Thermal Expansion Coefficient”, “Young's Modulus”, and “Flexural Strength” was made for the first sample for evaluation, that is, the laminated body of the low-temperature sintering ceramic layers and constraining layers, but can be considered substantially equal to the evaluation of the low-temperature sintering ceramic layer alone, because the low-temperature sintering ceramic material also penetrated into the constraining layers.

TABLE 2

| | | Firing | Thermal | | |
|---|---|---|---|---|---|
| | Firing | Shrinkage | Expansion | Young's | Flexural |
| Sample | Temperature | Ratio | Coefficient | Modulus | Strength |
| Number | [° C.] | [%] | [ppm/° C.] | [GPa] | [MPa] |
| 1 | 980 | 0.8 | 7.8 | 82 | 288 |
| 2 | 980 | 0.7 | 8.0 | 81 | 275 |
| 3 | 980 | 0.9 | 9.4 | 83 | 302 |
| 4 | 980 | 0.9 | 10.2 | 82 | 315 |
| 5 | 980 | 0.6 | 11.5 | 85 | 296 |
| 6 | 980 | 0.7 | 12.9 | 88 | 281 |
| 7 | 980 | 0.5 | 13.0 | 92 | 287 |
| 8 | 990 | 0.5 | 9.9 | 99 | 311 |
| 9 | 990 | 0.5 | 9.5 | 118 | 302 |
| 10 | 1000 | 0.4 | 9.2 | 136 | 318 |
| 11 | 940 | 1.0 | 9.8 | 79 | 239 |
| 12 | 920 | 1.2 | 9.9 | 77 | 203 |
| 13 | 900 | 1.1 | 9.8 | 76 | 182 |

In addition, the “Cracking” and “Fixing Strength of Surface conductor” were evaluated as shown in Table 3.

In particular, as for “Cracking”, the cross section in each position 1 mm inward from each phase-opposed end surface of the second fired sample for evaluation was observed through a scanning electron microscope (SEM) at 1000-fold magnification. The number of points to be observed was 30 for each end surface of one sample for evaluation, that is, 60 in total for both end surfaces. The sample was determined as “with cracking: x” if cracking or peeling at the interface between the copper plate and the laminated body section was identified even in one observed field of view, whereas the sample was determined as “without cracking: ∘” if cracking or peeling was not identified in any observed field of view.

In addition, as for the “Fixing Strength of Surface Conductor”, an Sn-plating coated copper wire of 1 mm in diameter was attached to the surface conductor of the third fired sample for evaluation with the use of an M705 solder to measure the peeling strength under the condition of tension rate: 2 mm/minute. Then, the measurement was made for the number of samples: 20, and the average value for the samples was regarded as the fixing strength of the surface conductor. This “Fixing Strength of Surface Conductor” was evaluated only for the samples determined as “∘” for “Cracking”.

For reference, the fixing strength of the surface conductor was 35 N, which was obtained in the case of the third sample for evaluation without the copper plate, that is, without any compressive stress applied from the copper plate.

TABLE 3

| | Difference in | | |
|---|---|---|---|
| | Thermal | | |
| | Expansion | | |
| | Coefficient | | Fixing Strength |
| Sample | from Copper | | of Surface |
| Number | Plate [ppm/° C.] | Cracking | Conductor [N] |
| 1 | 9.2 | X | — |
| 2 | 9.0 | ◯ | 47 |
| 3 | 7.6 | ◯ | 50 |
| 4 | 6.8 | ◯ | 49 |
| 5 | 5.5 | ◯ | 45 |
| 6 | 4.0 | ◯ | 43 |
| 7 | 3.7 | ◯ | 36 |
| 8 | 7.1 | ◯ | 43 |
| 9 | 7.5 | ◯ | 44 |
| 10 | 7.8 | X | — |
| 11 | 7.2 | ◯ | 44 |
| 12 | 7.1 | ◯ | 42 |
| 13 | 7.2 | X | — |

In the case of samples 2 to 9, 11, and 12 with the “Difference in Thermal Expansion Coefficient from Copper Plate” of 9 ppm/° C. or less as shown in Table 3, and with the Young's modulus less than about 120 GPa and the flexural strength of about 200 MPa as shown in Table 2, the “cracking” is “∘”, whereas the “Fixing Strength of Surface Conductor” exceeds “35 N” in the case without the copper plate, as shown in Table 3. From the foregoing, it is determined that samples 2 to 9, 11, and 12 can significantly reduce and prevent peeling between the low-temperature sintering ceramic layer and the copper plate and cracking in the low-temperature sintering ceramic layer, and can achieve a high anti-peeling strength for the surface conductor.

In addition, particularly when sample 6 is compared with sample 7, the “Difference in Thermal Expansion Coefficient from Copper Plate” shown in Table 3 is “4.0 ppm/° C.” for sample 6 and “3.7 ppm/° C.” for sample 7. Further, when a comparison is made for the “Fixing Strength of Surface Conductor” shown in Table 3, the “Fixing Strength of Surface Conductor” is “43 N” for sample 6, and “36 N” for sample 7. From the foregoing, it is determined that the “Difference in Thermal Expansion Coefficient from Copper Plate” adjusted to be 4 ppm/° C. or more can significantly improve the anti-peeling strength for the surface conductor.

In contrast to these samples, in the case of sample 1, as shown in Table 3, the “Difference in Thermal Expansion Coefficient from Copper Plate” is “9.2 ppm/° C.” which is greater than 9 ppm/° C., whereas the “cracking” is “x”.

In addition, in the case of sample 10, the “Young's Modulus” shown in Table 2 is “136 GPa” which is greater than 120 GPa, whereas the “cracking” is “x” as shown in Table 3.

In addition, in the case of sample 13, the “Flexural Strength” shown in Table 2 is “182 MPa” which is less than 200 MPa, whereas the “cracking” is “x” as shown in Table 3.

While the copper plate was preferably used as the metal substrate in the experimental example described above, it has been confirmed that similar results are produced even in the case of using a metal substrate other than the copper plate.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A metal base substrate comprising:
a metal substrate; and
a low-temperature sintering ceramic layer located on the metal substrate; wherein
a thermal expansion coefficient of the metal substrate is greater than a thermal expansion coefficient of the low-temperature sintering ceramic layer;
an average difference in thermal expansion coefficients of the metal substrate and the low-temperature sintering ceramic layer at approximately 25° C. to 400° C. is about 9 ppm/° C. or less; and
the low-temperature sintering ceramic layer has a Young's modulus less than about 120 GPa and a flexural strength of about 200 MPa or more.

2. The metal base substrate according to claim 1, wherein the average difference in the thermal expansion coefficients is about 4 ppm/° C. or more.

3. The metal base substrate according to claim 1, further comprising a constraining layer stacked on the low-temperature sintering ceramic layer.

4. The metal base substrate according to claim 3, wherein the low-temperature sintering ceramic layer is thicker than the constraining layer.

5. The metal base substrate according to claim 1, further comprising a laminated body section including the low-temperature sintering ceramic layer, a constraining layer, and a circuit pattern.

6. A metal base substrate comprising:
a metal substrate; and
a low-temperature sintering ceramic layer located on the metal substrate; wherein
a thermal expansion coefficient of the metal substrate is greater than a thermal expansion coefficient of the low-temperature sintering ceramic layer;
an average difference in thermal expansion coefficients of the metal substrate and the low-temperature sintering ceramic layer at approximately 25° C. to 400° C. is between about 4 ppm/° C. and about 9 ppm/° C.; and
the low-temperature sintering ceramic layer has a Young's modulus less than about 120 GPa and a flexural strength of about 200 MPa or more.

7. The metal base substrate according to claim 6, further comprising a constraining layer stacked on the low-temperature sintering ceramic layer.

8. The metal base substrate according to claim 7, wherein the low-temperature sintering ceramic layer is thicker than the constraining layer.

9. The metal base substrate according to claim 6, further comprising a laminated body section including the low-temperature sintering ceramic layer, a constraining layer, and a circuit pattern.

10. An electronic component device comprising:
a metal base substrate; and
a semiconductor element; wherein
the metal base substrate includes:
a metal substrate; and
a low-temperature sintering ceramic layer located on the metal substrate; wherein
a thermal expansion coefficient of the metal substrate is greater than a thermal expansion coefficient of the low-temperature sintering ceramic layer;
an average difference in thermal expansion coefficients of the metal substrate and the low-temperature sintering ceramic layer at approximately 25° C. to 400° C. is about 9 ppm/° C. or less; and
the low-temperature sintering ceramic layer has a Young's modulus less than about 120 GPa and a flexural strength of about 200 MPa or more.

11. The electronic component device according to claim 10, wherein the average difference in the thermal expansion coefficients is about 4 ppm/° C. or more.

12. The electronic component device according to claim 10, wherein the metal base substrate further comprises a constraining layer stacked on the low-temperature sintering ceramic layer.

13. The electronic component device according to claim 12, wherein the low-temperature sintering ceramic layer is thicker than the constraining layer.

14. The electronic component device according to claim 10, further comprising a laminated body section including the low-temperature sintering ceramic layer, a constraining layer, and a circuit pattern.

15. The electronic component device according to claim 10, further comprising surface conductors, interlayer connecting conductors, and in-plane wiring conductors connected with the semiconductor element.

16. The electronic component device according to claim 15, further comprising a bonding wire arranged to electrically connect one of the surface conductors to the semiconductor element.

17. A method for manufacturing a metal base substrate, the method comprising the steps of:
preparing a metal substrate including at least a surface containing a Cu constituent;
preparing a raw laminated body by stacking, on a surface of the metal substrate, a low-temperature sintering ceramic green layer; and
firing the raw laminated body at a temperature at which the low-temperature sintering ceramic green layer is sintered; wherein
a thermal expansion coefficient of the metal substrate is greater than a thermal expansion coefficient of the low-temperature sintering ceramic layer;
an average difference in thermal expansion coefficients of the metal substrate and the low-temperature sintering ceramic layer at approximately 25° C. to 400° C. is between about 4 ppm/° C. and about 9 ppm/° C.;
the low-temperature sintering ceramic layer has a Young's modulus less than about 120 GPa and a flexural strength of about 200 MPa or more.

18. The method according to claim 17, wherein the average difference in the thermal expansion coefficients is about 4 ppm/° C. or more.

19. The method according to claim 17, wherein the step of preparing a raw laminated body includes stacking a constraining layer on a surface of the low-temperature sintering ceramic green layer.

20. The method according to claim 19, wherein the low-temperature sintering ceramic layer is thicker than the constraining layer.
